(19) United States
(12) Patent Application Publication
(10) Pub. No.: US 2006/0039676 A1
(43) Pub. Date: Feb. 23, 2006

(54) Trick play behavior controlled by a user

(75) Inventors: Gerardus Wilhelmus Theodorus Van Der Heijden, Eindhoven (NL); Albert Rijckaert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/522,281

(22) PCT Filed: Jul. 10, 2003
(86) PCT No.: PCT/IB03/03144

§ 371 Date: Jan. 25, 2005

(30) Foreign Application Priority Data
Jul. 30, 2002 (EP) 02078130.8

(51) Int. Cl. H04N 5/783

(52) U.S. Cl. 386/68; 386/111

(57) ABSTRACT

A method and apparatus for providing user controlled implementation of trick play modes of operation of digital video data is disclosed. A user interface is provided on a video screen. The user is prompted to select a speed on the user interface at which the trick play mode will operate. The user is then prompted on the user interface to select how the selected speed is implemented. Alternatively, a list of possible implementations (predefined modes of operation) are displayed on the user interface from which the user can select the desired mode of operation.

### FIELD OF THE INVENTION

The invention relates to trick play behavior of digital video data, and more particularly to a method and apparatus for allowing the user to control how the requested trick play mode is implemented.

### BACKGROUND OF THE INVENTION

MPEG video employs three types of compressed pictures, i.e., intraframe encoded digital video data (I frames), forward predictive encoded data (P frames) and bi-directionally predictive encoded data (B frames). I and P-frames are called anchor frames. An I-frame can be decoded by itself without resort to other data. A P-frame requires data from a previously decompressed anchor frame to enable its decompression. A B-frame requires data from both preceding and succeeding anchor frames to allow its decompression.

MPEG compressed digital video is often stored on a video server or other storage systems like a DVD player, PVR box, a box containing a hard disk, etc., and is deliver on demand to a client. Many interactive video servers support “trick play” modes, i.e., fast-forward-play and fast-reverse-play (rewind). While watching a video, the client may request fast-forward play or fast rewind.

Several methods are used to allow interactive video servers to perform fast-forward-play and fast-rewind-play. A bit stream of MPEG compressed digital video data generally is divided into groups of pictures (GOPs), and each GOP begins with an I-frame. When digital video data is MPEG compressed at a fixed rate, for example, when the frame pattern of the GOP is fixed, I-frames occur in the bit stream at known positions (a known position is not needed in some examples) thereof and, thus, high speed reproduction of the video data by reproducing only I-frames therein is possible since the general position of each I-frame is known. Alternatively, the digital video data can be compressed at a variable rate.

In order to keep the data rate constant during fast-forward play, video servers use an ancillary data stream which is constructed as follows. The original stream can be used, but during fast forward/backward only the correct parts of the stream are selected. These selected parts of the stream are assembled in such a way that a correct MPEG stream results. This MPEG stream can be decoded by an MPEG decoder built according the MPEG standard. It will be understood by those skilled in the art that in case the decoder is flexible and its behavior is known that a stream can be generated which has more features/flexibility. The rewind function is provided by assembling the stream in a different way. This stream is constructed in the same manner as the ancillary stream for fast-forward play, except that every n'th picture of the original video is picked in the reverse order, starting with the last frame. The trick play modes are similar to those in D-VHS.

In addition, the fast-forward play and fast-rewind play can be implemented in various ways. For example, the length of time that each I-frame is displayed can also be varied. By varying the speed and the time each I-frame is displayed, many different visual presentations of the video data can be created. However, different users will prefer different visual presentations. Thus, there is a need for allowing individual users the ability to control the implementation of the trick play behavior so that the trick play implementation meets with the user's preferences.

### SUMMARY OF THE INVENTION

It is an object of the invention to improve user control over the implementation of trick play by providing a method and apparatus for providing user controlled implementation of trick play modes of operation of digital video streams.

An advantage of such a method and apparatus is that the user is able to implement trick play according to his own liking.

According to one embodiment of the invention, a method and apparatus for providing user controlled implementation of trick play modes of operation of digital video data is disclosed. A user interface is provided on a video screen. The user is prompted to select a speed on the user interface at which the trick play mode will operate. The user is then prompted on the user interface to select how the selected speed is implemented.

According to another embodiment of the invention, a list of possible implementations (predefined modes of operation) are displayed on the user interface from which the user can select the desired mode of operation.

These and other aspects of the invention will be apparent from and elucidated with reference to the embodiments described hereafter.

### BRIEF DESCRIPTION OF THE DRAWINGS

The invention will now be described, by way of example, with reference to the accompanying drawings, wherein:

FIG. 1 illustrates a block diagram of a audio-video apparatus suitable to host embodiments of the invention;

FIG. 2 illustrates a block diagram of a set-top box which can be used to implement at least one embodiment of the invention;

FIG. 3 illustrates a flow chart illustrating a method for providing user controlled implementation of trick play modes according to one embodiment of the invention;

FIG. 4 illustrates a user interface coupled to an embodiment of the invention; and

FIG. 5 illustrates a further user interface coupled to a further embodiment of the invention.

### DETAILED DESCRIPTION OF THE INVENTION

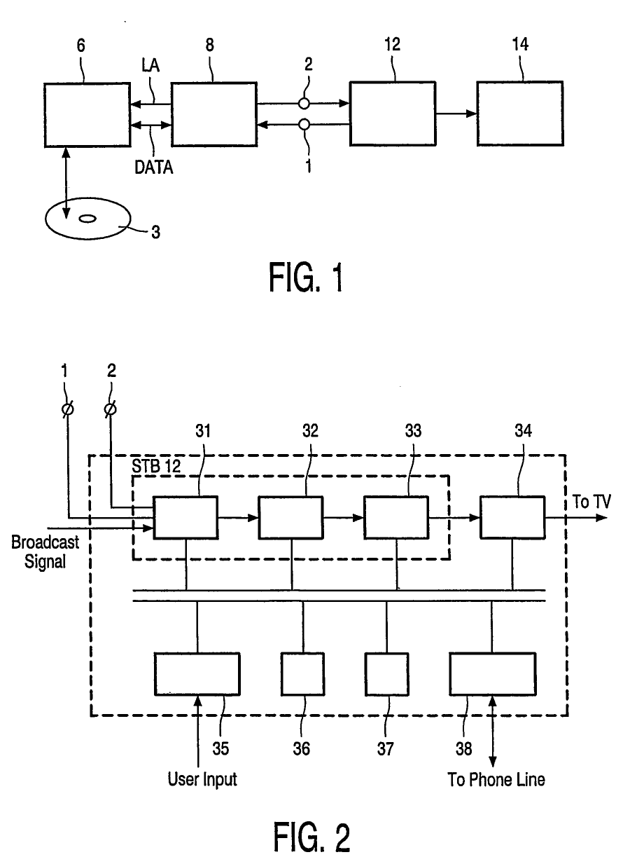

FIG. 1 illustrates an audio-video apparatus suitable to host the invention. The apparatus comprises an input terminal 1 for receiving a digital video signal to be recorded on a disc 3. Further, the apparatus comprises an output terminal 2 for supplying a digital video signal reproduced from the disc 3. These terminals may in use be connected via a digital interface to a digital television receiver and decoder 12 in the form of a set-top box (STB), which also receives broadcast signals from satellite, cable or the like, in MPEG TS format. The decoder 12 provides display signals to a display device 14, which may be a conventional television set.

The video recording apparatus as shown in FIG. 1 is composed of two major system parts, namely the disc subsystem 6 and the video recorder subsystem 8, controlling both recording and playback. The two subsystems have a number of features, as will be readily understood, including that the disc subsystem can be addressed transparently in terms of logical addresses (LA) and can guarantee a maximum sustainable bit-rate for reading and/or writing data from/to the disc.

Suitable hardware arrangements for implementing such an apparatus are known to one skilled in the art, with one example illustrated in patent application WO-A-00/00981. The apparatus generally comprises signal processing units, a read/write unit including a read/write head configured for reading from/writing to disc 3. Actuators position the head in a radial direction across the disc, while a motor rotates the disc, A microprocessor is present for controlling all the circuits in a known manner.

Referring to FIG. 2, a block diagram of a set-top box 12 is shown. It will be understood by those skilled in the art that the invention is not limited to a set top box but also extends to a variety of devices such as a DVD player, PVR box, a box containing a Hard disk (recorder module), etc. A broadcast signal is received and fed into a tuner 31. The tuner 31 selects the channel on which the broadcast audio-video-interactive signal is transmitted and passes the signal to a processing unit 32. The processing unit 32 demultiplexes the packets from the broadcast signal if necessary and reconstructs the television programs and/or interactive applications embodied in the signal. The programs and applications are then decompressed by a decompression unit 33. The audio and video information associated with the television programs embodied in the signal is then conveyed to a display unit 34, which may perform further processing and conversion of the information into a suitable television format, such as NTSC or HDTV audio/video. Applications reconstructed from the broadcast signal are routed to random access memory (RAM) 37 and are executed by a control system 35.

The control system 35 may include a microprocessor, micro-controller, digital signal processor (DSP), or some other type of software instruction processing device. The RAM 37 may include memory units which are static (e.g. SRAM), dynamic (e.g. DRAM), volatile or non-volatile (e.g., FLASH), as required to support the functions of the set-top box. When power is applied to the set-top box, the control system 35 executes operating system code which is stored in ROM 36. The operating system code executes continuously while the set-top box is powered in the same manner as the operating system code of a typical personal computer and enables the set-top box to act on control information and execute interactive and other applications. The set-top box also includes a modem 38. The modem 38 provides both a return path by which viewer data can be transmitted to the broadcast station and an alternate path by which the broadcast station can transmit data to the set-top box.

Although the term “set-top box” is used herein, it will be understood that this term refers to any receiver or processing unit for receiving and processing a transmitted signal and conveying the processed signal to a television or other monitor. The set-top box may be in a housing which physically sits on top of a television, it may be in some other location from the television, or it may be incorporated into the television itself.

As noted above, a viewer can use trick play modes of operation when viewing recorded programs. According to one embodiment of the invention, the user can use a user interface on the display screen of the television to select the speed at which the trick play mode is performed and how the trick play mode is implemented. The user interface is stored in either the ROM 36 or the RAM 37 and presented on the display device by means of the control system 35 and the display unit 34. In this illustrative example, consider a GOP with a size of 12, and the GOP is comprised of I, B, and P frames configured as IBBPBBPBBPBBI. For any selected speed, there are many different ways of implementing the selected trick play mode. At one extreme, each I-frame in the video data stream can be displayed for a very short period of time creating a very fast repetition of I-frames on the display. At the other extreme, a plurality of subsequent I-frames can be skipped after an I-frame is displayed and the displayed I-frame can be shown or repeated for an extended period of time creating a slide show presentation of the displayed I-frames. For example, each I-frame can be shown for 40 ms (or 33 ms in NTSC). The user can also select implementations between the two extremes by selecting different values for how many I-frames to skip (0, 1, 2, 3, . . . ) and how long each displayed I-frame is displayed or repeated.

For example, the user can select 6× forward speed and the fast forward can be implemented as follows:
I₀, I₀, I₀, I₀, I₂, I₂, I₂, I₂, I₄, I₄, I₄, I₄, I₆, I₆, I₆, I₆, . . . or
I₀, I₀, I₁, I₁, I₂, I₂, I₃, I₃, I₄, I₄, I₅, I₅, I₆, I₆, I₇, I₇, . . .
where the subscript indicates the i-th I-frame in the original sequence of video data In both cases, no P or B-frames are shown. In the first case, every other I-frame is skipped and each displayed I-frame is displayed four times which creates more of the slide show presentation. In the second case, every I-frame is shown twice which creates a fast repetition of I-frames. It will be understood that B or P frames or modified B or P frames can be inserted into the modified video stream to generate more fluent motion, or to eliminate certain interlace artifacts.

The user interface can have different practical embodiments. For example, the user interface can list a number of different implementation scenarios to choose from. Alternatively, the user interface can allow the user to select how many I-frames are skipped and how long the displayed I-frames should be displayed.

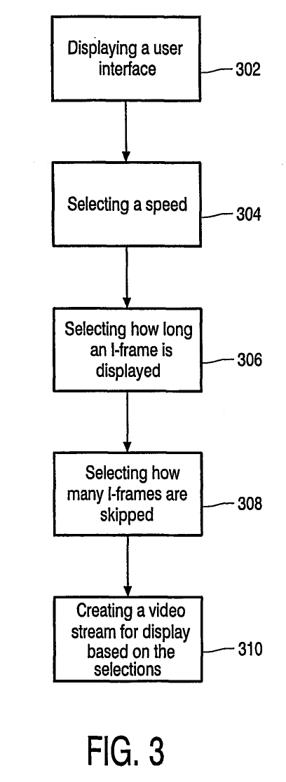

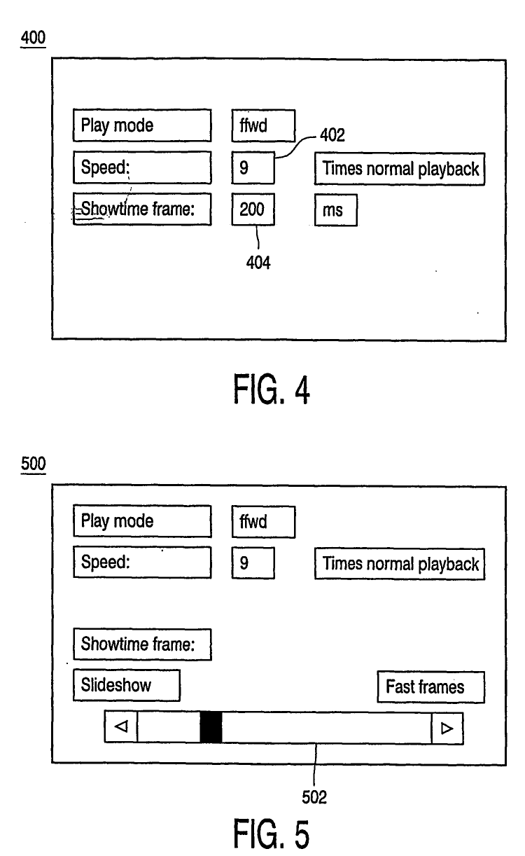

An illustrative embodiment of the invention will now be described with reference to FIG. 3 which is a flow chart illustrating a method for providing user controlled implementation of trick play modes of operation. When a user selects a trick play mode, the control system 35 generates a user interface 400 (FIG. 4) on the display device 14 in step 302. The user can interact with the user interface in a variety of known ways, for example, by a remote control device, a keyboard, etc. The user interface 400 allows the user to select a speed for the trick play mode in step 304. The user interface can prompt the user to enter a speed 402 or provide a list of possible speeds to choose from. The user can then select a time period 404 how long an I-frame will be displayed during the trick play mode in step 306.

The user interface 400 prompts the user to enter a time or provide a list of times to choose from. It will be understood that a single I-frame can be displayed for the entire selected time or a series of the same I-frame can be repeatedly shown for the selected period of time.

In a further embodiment, the user can select how many successive I-frames will be skipped after an I-frame is displayed in step 308. The user interface can prompt the user to enter the number of frames to skip or provide a list of possible choices to choose from. The control system 35 takes the selections and then creates a video stream for display in a known manner based on the selected criteria in step 310.

In a further embodiment of the method according to the invention, a user is provided a slider 502 by a further user interface 500. In this way, a user may choose various options between showing an I-frame for the already mentioned 40 ms (shortest possible time to show a frame) and showing only one I-frame. For an inexperienced user with no technical background, this is an intuitive way of applying an embodiment of the method according to the invention. The product of speed [frames per second] (all frames, also the non-displayed ones)* duration of a display of a displayed frame may be stored as a default for further trick play actions.

In addition, the control system 35 can review the criteria selected by the user to determine if the selected values can be used to successfully create a video stream. If there is a problem with implementing the selected values, the control system 35 can prompt the user on the user interface to select different values. In the alternative, the control system 35 can display a list of possible values for the user to choose from. In addition, the selected values can be stored for later recall. According to another embodiment of the invention, the user can also select how many P and/or B-frames or modified P and/or B frames can be inserted into the video stream so as to reduce or eliminate certain artifacts, for example, which can occur from interlacing.

It will be understood that the different embodiments of the invention are not limited to the exact order of the above-described steps as the timing of some steps can be interchanged without affecting the overall operation of the invention. Furthermore, the term “comprising” does not exclude other elements or steps, the terms “a” and “an” do not exclude a plurality and a single processor or other unit may fulfil the functions of several of the units or circuits recited in the claims.

The invention may be summarised as follows: A method and apparatus for providing user controlled implementation of trick play modes of operation of digital video data is disclosed. A user interface is provided on a video screen. The user is prompted to select a speed on the user interface at which the trick play mode will operate. The user is then prompted on the user interface to select how the selected speed is implemented. Alternatively, a list of possible implementations (predefined modes of operation) are displayed on the user interface from which the user can select the desired mode of operation.

1. A method for providing user controlled implementation of trick play modes of operation of digital video data, comprising the steps of:
a) providing (302) a user interface (400) on a display device (14);
b) prompting the user to select a speed (402) on the user interface at which the trick play mode will operate;
c) prompting the user on the user interface to select how the selected speed is implemented.

2. The method according to claim 1, wherein the trick play mode is a fast forward operation.

3. The method according to claim 1, wherein the trick play mode is a fast rewind operation.

4. The method according to claim 1, wherein the step of selecting how the selected speed is implemented comprises the steps of:
a) selecting (306) how many successive I-frames are skipped after a displayed I-frame; and
b) selecting (306) how long each displayed I-frame is displayed.

5. The method according to claim 1, wherein the step of selecting how the selected speed is implemented comprises the step of selecting:
a) a time period (404) how long a frame is displayed; and
b) a speed (402) at which the digital video data is displayed;
c) and the method further comprises the step of computing how many frames are skipped after displaying one.

6. The method according to claim 1, further comprising the step of storing the selected implementation for later recall.

7. The method according to claim 1 wherein the digital video data is compressed according to the MPEG standard, further comprising the step of prompting the user on the user interface to select how many B and P-frames are inserted during the trick play mode.

8. The method according to claim 1, wherein the step of selecting how the selected speed is implemented comprises the steps of:
a) selecting how long each I-frame is displayed; and
b) selecting how many times each I-frame is displayed.

9. The method according to claim 1, further comprising the step of creating a video stream for display based on the selected criteria.

10. The method according to claim 1, wherein a list of possible implementations are displayed on the user interface for the user to select from.

11. An apparatus (102) for providing user controlled implementation of trick play modes of operation of digital video data, comprising:
Means (34, 35) for providing a user interface on a video screen;
means for prompting the user to select a speed on the user interface at which the trick play mode will operate;
means for prompting the user on the user interface to select how the selected speed is implemented; and
user input means for receiving a user input.
